(19) United States
(12) Patent Application Publication
(10) Pub. No.: US 2004/0147036 A1
(43) Pub. Date: Jul. 29, 2004

(54) Means and method for determining the content of sulfurous acid in liquids

(76) Inventors: Karl-Dieter Krenn, Pfungstadt (DE); Dieter Tanzer, Darmstadt (DE)

Correspondence Address: Millen White, Zelano & Branigan, Arlington Courthouse Plaza I, 2200 Clarendon Boulevard Suite 1400, Arlington, VA, 22201, US

(21) Appl. No.: 10/477,591

(22) PCT Filed: Apr. 24, 2002
(86) PCT No.: PCT/EP02/04491

(30) Foreign Application Priority Data
May 23, 2001 (DE) 101252854

(51) Int. Cl. G01N 1/00

(52) U.S. Cl. 436/119; 422/61

(57) ABSTRACT

The invention relates to a method and test kit for detecting, in particular, free sulfite in aqueous samples. The sample is introduced into a closeable receptacle, is preferably rendered slightly acidic with acid, and a test strip is used to determine the sulfite content in the gas phase above the sample. The analysis can ensue visually or reflectometrically. The inventive test kit for carrying out the method comprises a closeable receptacle and a test strip for analyzing sulfite.

The invention relates to a method for the determination of the content of sulfurous acid in liquids, in particular in beverages, in which the determination is carried out in the gas space above the sample by means of a test stick, and to a corresponding test kit.

The addition of sulfur dioxide or sulfites to foods, known in technical jargon as “sulfiting”, is a frequently used method for extending the storage life of foods, such as, for example, dry fruit, potato products and fish products (Katalyse (Institut für angewandte Umwelfforschung): Neue Chemie in Lebensmitteln [Catalysis (Institute for Applied Environmental Research): New Chemistry in Foods] (1995), Verlag Zweitausendeins, Frankfurt am Main; Belitz, Grosch: Lehrbuch der Lebensmittelchemie [Textbook of Food Chemistry], 4th Edition (1992), Verlag Springer, Berlin).

By far the greatest importance of “sulfiting” is in winemaking. The use of sulfurous acid for must or wine treatment is one of the most important measures in winemaking, which not only improves the storage life, but also can have a crucial effect on the character and quality of a wine (Würdig, Wohler: Chemie des Weines, Handbuch der Lebensmitteltechnologie [Chemistry of Wine, Handbook of Food Technology] (1989) Verlag Eugen Ulmer, Stuttgart; Bergner, Lemperle: Weinkompendium [Wine Compendim](1998) Verlag Hirzel, Stuttgart; Ullmann, Enzyklopädie der technischen Chemie [Encyclopaedia of Industrial Chemistry] (1983), Volume 24, Chapter on Wine; Verlag Chemie, Weinheim).

In wine, the sulfurous acid exists in free form and bound to various constituents. All state forms give total sulfurous acid. Free sulfurous acid is defined as the fraction in the form of SO₂ or in mineral binding in the form of H₂SO₃, HSO₃⁻and SO₃²⁻. The bound sulfurous acid is the difference between total sulfurous acid and free sulfurous acid.

In winemaking, sulfurous acid is added a number of times at the various stages of development. The majority of the added sulfurous acid is bound by various wine constituents, in particular acetaldehyde. Only a small part is in free form. In order to set a suitable amount of free sulfurous acid (about 30-50 mg/l), the wines require quite different amounts of added sulfur owing to greatly differing contents of SO₂-binding substances. The prerequisite for optimum dosage is knowledge of the current content of free and bound sulfite.

Since the uptake of sulfurous acid or salts thereof has clearly adverse health effects, which are evident in people of a sensitive nature in headaches, nausea and vomiting, the admissible total contents of sulfurous acid in various foods are legally prescribed (Volmer, Josst, Schenker, Sturm, Vreden: Lebensmittelführer [Food Guide], Volumes 1 and 2, 2nd Edition (1995), Verlag Thieme, Stuttgart).

In Germany at present, for example, two grams of sulfur dioxide may be employed per kilogram of dried apricots, pears or peaches, 1.5 grams in dried apples, pineapples and quinces, and 0.5 gram in dried bananas, melons and lemons.

Sulfiting must be indicated on the label from 50 mg of sulfur dioxide in one kilogram of dried fruit.

In order to maintain the pale colour, up to 100 mg of sulfur dioxide may be added per kilogram of potato products.

In German wines, the following maximum contents of total sulfurous acid are allowed:

225 mg/l in red wine

275 mg/l in white and rosé wine

300 mg/l in Spätlese wine

350 mg/l in Auslese wine

400 mg/l in Beerenauslese and Trockenbeerenauslese wine

Grape juice, by contrast, may only contain 10 mg/l.

The determination of the content of sulfurous acid is therefore of considerable importance in food analysis, in particular in wine analysis.

A distinction is made between determination methods which determine only the free sulfurous acid and methods which determine the total sulfurous acid. A further distinction can be made between simple and precise methods. The simple methods involve direct iodometric titration, while the precise methods are distillative methods with subsequent titration or are enzymatic determination methods (Würdig, Wohler: Chemie des Weines [Chemistry of Wine], Handbuch der Lebensmitteltechnologie [Handbook of Food Technology] (1989) Verlag Eugen Ulmer, Stuttgart; Rapp: Weinanalytik [Wine Analysis] (1993), Verlag Springer, Heidelberg; Schmitt: Aktuelle Weinanalytik [Modern Wine Analysis], 2nd Edition (1983), Verlag Heller, Schwäbisch Hall; DE 2126056).

Direct titration methods have the major disadvantage that other reductones (for example ascorbic acid) present in the sample interfere with the determination and result in excessively high findings. In addition, the inherent colour of a sample (for example red juices) frequently results in difficulties in recognising the titration end point in visual titrations.

A common feature of all precise methods is that the determination is very complex and time-consuming. The determination can only be carried out by trained personnel and requires corresponding equipment provision.

Analysis with solid, sorptive supports, so-called test sticks, has recently increased in importance. The main advantages of these dry-chemical methods include, in particular, simple handling and straightforward disposal owing to the small amounts of reagent. All or the majority of the reagents necessary for the determination reaction are embedded in corresponding layers of a solid, sorptive or swellable support, to which the sample is applied. After contact of the reaction zone with the sample, the determination reaction proceeds. The colour formed is a measure of the amount of analyte to be determined and can be evaluated visually, i.e. semi-quantitatively, or quantitatively using simple reflectometers.

Test sticks for the determination of sulfite are commercially available (for example Merck MQ or RQ Sulfite Test, Art. 1.10013 and 1.16987 respectively). For the analysis, the test sticks are dipped into the sample. After suitable sample preparation, determination of the free and total sulfurous acid is thus possible (for example Merck RQ Sulfite Test in Wine, Art. 1.16122).

The main disadvantage of these test sticks is that the determination cannot be carried out with sufficient accuracy in the region below about 30 mg/l of SO₂. Use for coloured samples, such as, for example, red wines, is not possible owing to the interference through the inherent colour of the sample. Decoloration of the sample using known decolorisation agents with the aim of interference-free determination is generally associated with sulfite loss and thus cannot be carried out before the sulfite analysis.

The present invention has the object of providing a method for the determination of sulfurous acid in aqueous samples which does not have the above disadvantages, can be carried out simply and quickly and is inexpensive. In particular, the method according to the invention should enable not only semi-quantitative, visual evaluation, but also quantitative evaluation using a reflectometer.

It has been found that the determination of sulfite in aqueous samples is very sensitive and fast if the determination is not carried out, as known, in solution, but instead by means of a test strip in the gas space above the sample. SO₂ is expelled particularly effectively from the aqueous sample by slight acidification of the sample using, for example, sulfuric acid, and can be detected by means of a moistened test strip held above the sample solution. In this way, an interfering influence of coloured samples, such as, for example, red wine, on the analytical result is also prevented.

The present invention therefore relates to a method for the determination of sulfurous acid in aqueous samples, characterised by the following method steps:

provision of a sealable sample container;

addition of a certain amount of the aqueous sample to the sample container;

wetting of a test strip for sulfite analysis;

optionally addition of reagents for the liberation of SO₂ to the sample. This can either be a weak acid for the liberation or expulsion of free SO₂. Alternatively, this can be the addition of a strong acid or firstly caustic lye and subsequently acid for the liberation and expulsion of bound or free and bound SO₂.

Introduction of the test strip into the gas space above the sample and sealing of the sample container;

withdrawal and evaluation of the test strip.

In a preferred embodiment, the sample is firstly acidified before the introduction of the test strip into the gas space. For the preferred determination of free sulfurous acid, it is only slightly acidified. For the determination of total sulfurous acid, the sample is generally mixed with relatively large amounts of strong acids or preferably firstly with caustic lye for the liberation of bound SO₂ and then with acid for the expulsion of the SO₂ from he solution.

In a preferred embodiment, the acidification of the sample is carried out using sulfuric acid.

In a preferred embodiment, the wetting of the test strip is carried out using a buffer which has a pH of between 8 and 10.

In a particularly preferred embodiment, the wetting of the test strip is carried out using imidazole buffer.

In a preferred embodiment, the analysis of the test strip is carried out by reflectometry.

In a preferred embodiment, use is made of a test strip on which sulfite is determined as Na₅[Fe(CN)₅SO₃].

The present invention also relates to a test kit for carrying out the method according to the invention which consists at least of a test strip for sulfite analysis and a sealable container.

In a preferred embodiment, the test kit additionally contains acid for acidification of the sample.

In another preferred embodiment, the test kit additionally contains buffer solution for wetting of the test strip.

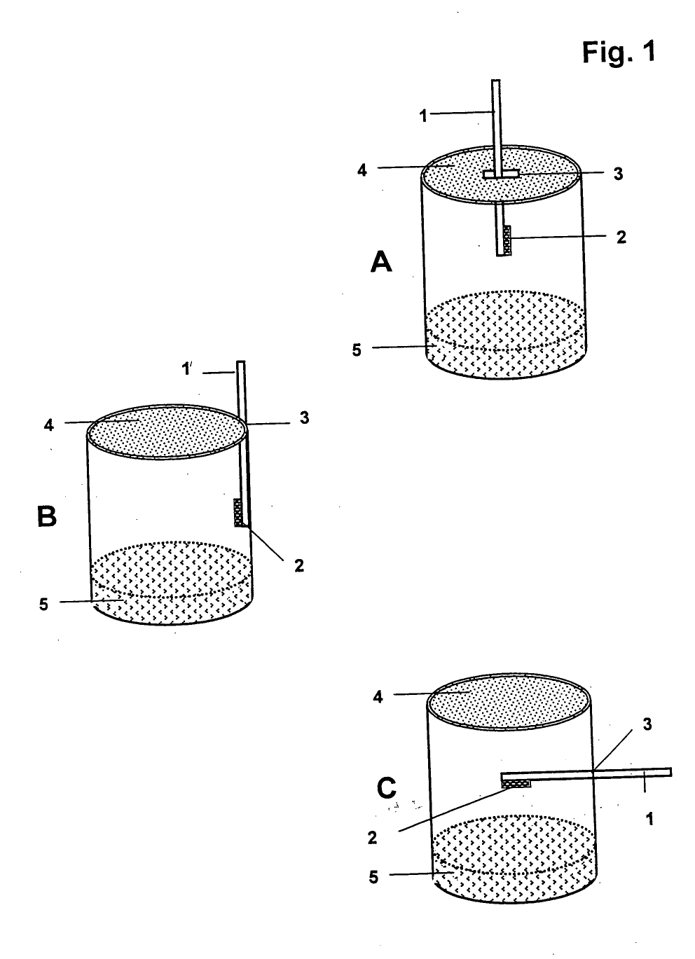

FIG. 1 shows possible embodiments of the sample container for the test kit according to the invention.

The method according to the invention for the determination of sulfurous acid in aqueous solutions is based on selective determination using a correspondingly pretreated test strip in the gas phase above the sample. The SO₂ content in the gas phase above the sample is a measure of the concentration of sulfite in the sample. The determination system is in the form of an impregnated matrix, i.e. all reagents necessary for the selective determination of sulfite (colouring reagent, buffer system, optionally also stabilisers and solubilisers) are embedded in a sorptive support. The resultant colour reaction is evaluated by reflectometry or visually by comparison with a colour card.

The sulfite analysis test sticks employed in accordance with the invention have a reagent system for sulfite determination. Possible determination systems are all reagent combinations which result in a sulfite-selective determination reaction. Particular preference is given to determination as Na₅[Fe(CN)₅SO₃] with formation of a red colour. A possible reagent system for this determination is a mixture of potassium hexacyanoferrate (II), zinc sulfate and sodium nitroprusside. A further possibility for the determination of sulfite is decoloration of malachite green or fuchsin. Further information on reagents for sulfite analysis is given, for example, in Jander/Blasius, Lehrbuch der analytischen und praparativen anorganischen Chemie [Text-book of Analytical and Preparative Inorganic Chemistry], Hinzel Verlag, Stuttgart 1979 or in B. L. Wedzicha, Chemistry of Sulphur dioxide in Foods, Chapter 2 Analytical, Elsevier Applied Science Publishers, London N.Y.

Sorptive supports which can be used are all materials which are usually in use for such tests. The most widespread is the use of filter paper, but it is also possible to employ other sorptive cellulose or plastic products. The sorptive supports are impregnated in a known manner with impregnation solutions which comprise all reagents necessary for the determination of sulfite. The impregnated and dried papers can be suitably cut to size and stuck or heat-sealed to support films in a known manner.

In order to facilitate reaction of the analyte in the gas phase with the reagent system of the test stick, the latter must be moistened before the reaction. Water has in principle proven suitable for the moistening. Surprisingly, it has been found that moistening with a buffer system in the pH range 8-10 results in particularly high sensitivity and a uniform colour change on the test stick. Suitable buffer systems for setting the pH are those which are compatible with the other constituents of the test and which do not interfere with the determination reaction. Suitable buffer systems are all systems which set the desired pH range, such as, for example, phosphate buffer or tris buffer. Also suitable are buffer systems based on amines, particularly preferably heterocyclic amines. Examples of particularly suitable buffer systems are imidazole, 1-methylimidazole, 2-methylimidazole, pyrazole, pyrimidine, pyridazine, piperazine, triazole and triazine buffers, or derivatives or mixtures thereof. Suitable solvents, depending on the buffer system, are preferably water or mixtures of alcohols, typically branched or unbranched C1 to C6-alcohols, or of glycerol with water. Particular preference is given to an alcoholic imidazole buffer which has an imidazole content of 0.1-2.5% by weight and an alcohol content in the range 25-75% by volume.

In addition, it has been found that buffer systems based on amines, especially heterocyclic amines, in particular imidazole buffer, exert a stabilising effect on the colour action of the developed test strip. In particular in analyses in which the development and evaluation of the test strip takes more than 5 to 10 minutes, the test strip dries out and the colour may bleach out. This bleaching-out is only observed to a very small extent, or not at all, on use of test strips which have been treated in advance with buffers based on amines, in particular imidazole buffer. These buffers are therefore particularly suitable for the wetting of test strips whose colour development is to remain for some time after the incubation time in the sample container, for example, for visual comparison or for documentation purposes.

The method according to the invention is preferably suitable for the determination of free sulfurous acid in aqueous samples. Determination of free sulfite in the liquid sample solution can be carried out directly using the moistened, sulfite-selective test stick. An increase in the sensitivity of the determination system can be achieved by slight acidification of the sample solution. The acidification must be carried out in such a way that bound sulfurous acid is not liberated and included in the determination.

In principle, all acids are suitable for the acidification. In general, the concentration of the acids in the sample should be between 0.05 and 1 mol/l, preferably between 0.05 and 0.5 mol/l. Sulfuric acid has proven particularly suitable. The concentration of sulfuric acid in the sample should typically be in the range 0.05-0.5 mol/l.

For the determination of total sulfurous acid, the bound fraction of the sulfurous acid must first be liberated. This is typically carried out by treatment of the sample with relatively large concentrations of strong acid or by treatment of the sample with caustic lye and subsequent addition of acid, if necessary supported by additional heating.

In order to carry out the method according to the invention, a defined amount of the sample, if necessary diluted with water, is, for the determination of free sulfurous acid, introduced into a sealable sample container. A test strip according to the invention is wetted with water or preferably buffer solution. The sample is subsequently preferably slightly acidified in order to increase the sensitivity, the test strip is introduced into the sample container in such a way that it is located in the gas space above the sample solution, and the container is sealed. These method steps should be carried out quickly. A colour development which can be analysed visually or by reflectometry occurs on the test strip within a short time (usually within 0.5 to 10 minutes).

For the determination of total sulfurous acid, the sample is, before introduction of the test strip, treated with strong acid or firstly with caustic lye and then with acid and, if necessary, heated in order to digest the sample and to liberate the bound sulfurous acid.

If the free sulfurous acid is to be determined first followed by the bound fraction, firstly the method for the determination of free sulfite can be carried and the sample subsequently digested and the bound fraction of the sulfite determined in a second analysis using a fresh test strip.

An analysis kit according to the invention is particularly suitable for carrying out the method according to the invention. This analysis kit contains at least one test strip for sulfite analysis and a sealable sample container, in which the test strip can be fixed in the gas space above the sample. It preferably additionally contains buffer solution for moistening of the test strip and acid for acidification of the sample and, if desired, caustic lye for liberation of bound SO₂. The analysis kit may optionally contain further constituents, such as, for example, standard solutions, a description of the method or a colour chart for visual evaluation.

Possible embodiments of sample containers for the analysis kit according to the invention are depicted diagrammatically in FIG. 1. They must be designed in such a way that a sufficiently large amount of aqueous sample (5) can be introduced and a sufficiently large gas space remains above the sample in order to place the test strip (1) with the support zone (2), on which the determination reagents are located. The ratio between the volume of gas space and the sample is typically between 10:1 and 50:1. The container must be sealable, for example, by means of a stopper or a screw cap (4). In accordance with the invention, the term sealable container is also taken to mean a container which has a small aperture for the introduction of the test strip. The test strip can be introduced into the container and fixed via an aperture (3) in the cap, for example as depicted in FIG. 1A. It is likewise possible to clamp the test strip, as depicted in FIG. 1B, at the edge of the cap on sealing the container. FIG. 1C shows an embodiment in which the test strip is introduced into the container via a side aperture (3) in such a way that the support zone (2) of the test strip faces in the direction of the sample.

The method according to the invention and the analysis kit according to the invention thus offer for the first time a sensitive way of determining free or free and bound sulfite in aqueous samples without major equipment complexity. The analysis can be carried out within a few minutes, even outside the laboratory, for example directly at the sampling site. The measurement of SO₂ in the gas phase avoids interference by other substances present in the sample or interfering influences due to the inherent colour of the sample.

The method according to the invention offers the possibility of determining sulfite contents down to about 0.1 mg/l rapidly and simply.

Even without further comments, it is assumed that a person skilled in the art will be able to utilise the above description in its broadest scope. The preferred embodiments and examples should therefore merely be regarded as descriptive disclosure which is absolutely not limiting in any way.

The complete disclosure content of all applications, patents and publications mentioned above and below, in particular the corresponding application DE 101 25 285.4, filed on 23.05.2001, is incorporated into this application by way of reference.

### EXAMPLES

1. Determination of Free Sulfurous Acid—Reflectometric Evaluation of the Reaction Colour:

Production of the Test Sticks:

The following impregnation solution is applied to a filter paper (Binzer, 1450 CV; acid-washed) and then dried using warm air. The paper is heat-sealed to a white support film using hot-melt adhesive (for example Dynapol® S 1401 adhesive) and cut into strips in a suitable manner to give a reaction zone measuring about 6 mm×8 mm.

Composition of the Impregnation Solution:

6 g of zinc acetate dihydrate, 10 g of imidazole and 0.85 g of sodium nitroprusside are dissolved successively in 100 ml of methanol.

Composition of the Buffer Solution:

0.3 g of imidazole is dissolved in a mixture of 209 of 2-propanol and 25 g of water.

Preparation of the Standard Solutions:

Aqueous standard solutions are prepared by weighing out suitable amounts of sodium sulfite into distilled water.

Analysis: Determination of Free Sulfurous Acid

| | | |
|---|---|---|
| 1) Prepared | 1.0 ml | Introduce into the test container |
| sample solution | | and seal |
| 2) Buffer solution | 1 drop | Moisten reaction zone of the |
| | | analysis stick and decant on a |
| | | multipurpose cloth. |
| 3) 0.5 molar | 0.25 ml | Open test container and add |
| sulfuric acid | | dropwise. |
| | | Immediately close cap of |
| | | measurement container with stick |
| | | suitably attached (see FIG. 1) |

Depending on the degree of sulfite in the sample solution, a pink to brick-red colour forms which can be evaluated by comparison with a colour card.

For quantitative evaluation, the test strips are, after a suitable reaction time (5 minutes), evaluated in a small diode-based hand reflectometer (RQflex® reflectometer). Table 1 shows the correlation between the measured relative remission (%) and the sulfite content.

TABLE 1

| SO₂ (mg/l) | % rem |
|---|---|
| 0 | 82 |
| 4 | 72 |
| 8 | 64 |
| 16 | 51 |
| 24 | 42 |
| 32 | 35 |
| 40 | 30 |
| 60 | 24 |

2. Practical Test: Determination of Free Sulfurous Acid

The method according to the invention was used to analyse various wine samples, and the result was compared with an electrometric titration method as described by Schmitt: Aktuelle Weinanalytik [Modern Wine Analysis], 2nd Edition (1983), Verlag Heller, Schwäbisch Hall.

As can be seen from the results, very good agreement with the electrometric method is achieved. The method according to the invention is thus ideally suitable for rapid and sensitive checking of the SO₂ content.

| | Test strip with refl. | |
|---|---|---|
| | evaluation | Electrometric titration |
| Wine sample | SO₂ [mg/l] | SO₂ [mg/l] |
| White wine 1 | 19.1 | 21.8 |
| White wine 2 | 2.4 | 3.0 |
| White wine 3 | 37.8 | 42.0 |
| White wine 4 | 9.7 | 9.4 |
| White wine 5 | 14.5 | 16.6 |
| White wine 6 | 45.6 | 46.6 |
| White wine 7 | 36.7 | 32.4 |
| White wine 8 | 47.6 | 48.8 |
| Red wine 1 | 14.3 | 14.8 |
| Red wine 2 | 41.1 | 48.4 |
| Red wine 3 | 28.9 | 29.9 |
| Red wine 4 | 16.7 | 19.6 |
| Red wine 5 | 14.2 | 18.4 |
| Red wine 6 | 9.4 | 12.1 |

3. Determination of Total Sulfurous Acid—Reflectometric Evaluation of the Reaction Colour:

All conditions as described in Example 1.

Analysis: Determination of Total Sulfurous Acid

| | | |
|---|---|---|
| 1) Prepared | 1.0 ml | Introduce into the test container |
| sample solution | | and seal |
| 2) Buffer solution | 1 drop | Moisten reaction zone of the |
| | | analysis stick and decant on a |
| | | multipurpose cloth. |
| 3) 0.1 molar | 0.5 ml | Open test container, add dropwise |
| NaOH | | and leave to stand for 1 minute |
| 4) 0.5 molar | 0.25 ml | Open test container and add |
| sulfuric acid | | dropwise. |
| | | Immediately close cap of the |
| | | measurement container with stick |
| | | suitably attached (see FIG. 1) |

Depending on the degree of sulfite in the sample solution, a pink to brick-red colour forms which can be evaluated by comparison with a colour card.

For quantitative evaluation, the test strips are, after a suitable reaction time (5 minutes), evaluated in a small diode-based hand reflectometer. (RQflex® reflectometer). Table 2 shows the correlation between the measured relative remission (%) and the sulfite content.

TABLE 2

| SO₂ (mg/l) | % rem |
|---|---|
| 0 | 82 |
| 25 | 73 |
| 50 | 64 |
| 100 | 52 |
| 150 | 42 |
| 200 | 34 |
| 300 | 25 |

4. Practical Test: Determination of Total Sulfurous Acid

The method according to the invention was used to analyse various wine samples, and the result was compared with an electrometric titration method as described in Example 2.

| | Test strip with refl. | |
|---|---|---|
| | evaluation | Electrometric titration |
| Wine sample | SO₂ [mg/l] | SO₂ [mg/l] |
| White wine 1 | 235 | 252 |
| White wine 2 | 142 | 135 |
| White wine 3 | 151 | 140 |
| Red wine 1 | 109 | 106 |
| Red wine 2 | 77 | 74 |

1. Method for the determination of sulfurous acid in aqueous samples, characterised by the following method steps:
provision of a sealable sample container and a test strip for sulfite analysis;
addition of a certain amount of the aqueous sample to the sample container;
wetting of the test strip;
optionally addition of reagents to the sample for the liberation of SO₂;
introduction of the test strip into the gas space above the sample and sealing of the sample container;
withdrawal and evaluation of the test strip.

2. Method according to claim 1, characterised in that the sample is acidified before the introduction of the test strip.

3. Method according to claim 2, characterised in that the acidification of the sample is carried out using sulfuric acid.

4. Method according to one of claims 1 to 3, characterised in that the wetting of the test strip is carried out using a buffer which has a pH of between 8 and 10.

5. Method according to claim 4, characterised in that the wetting of the test strip is carried out using imidazole buffer.

6. Method according to one or more of claims 1 to 5, characterised in that the analysis of the test strip is carried out by reflectometry.

7. Method according to one or more of claims 1 to 6, characterised in that a test strip is used with which sulfite is determined as Na₅[Fe(CN)₅SO₃].

8. Test kit for carrying out the method for the determination of sulfurous acid in aqueous samples according to one or more of claims 1 to 7, at least having a test strip for sulfite analysis and a sealable container.

9. Test kit according to claim 8, additionally having acid for acidification of the sample.

10. Test kit according to one of claims 8 and 9, additionally having a buffer solution for wetting of the test strip.
